(19) United States
(12) Patent Application Publication
(10) Pub. No.: US 2004/0160433 A1
(43) Pub. Date: Aug. 19, 2004

(54) Display driving apparatus

(75) Inventors: Tetsuya Shigeta, Yamanashi-ken (JP); Tetsuro Nagakubo, Tokyo (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/733,290

(22) Filed: Dec. 12, 2003

(30) Foreign Application Priority Data
Feb. 19, 2003 (JP) 2003-41455

(51) Int. Cl. G09G 5/00

(52) U.S. Cl. 345/204

(57) ABSTRACT

A video signal processing section selects a display panel driving sequence scheme corresponding to the signal processing scheme to be performed on an input video signal to supply an instruction signal designating the driving sequence scheme to a display panel driving section together with the video signal on which the signal processing is performed. The display panel driving section drives the display panel in accordance with the driving sequence designated by the instruction signal on the basis of the video signal supplied from the video signal processing section.

### BACKGROUND OF THE INVENTION

1. Field of the Invention

The present invention relates to a driving apparatus of a display panel and the like.

2. Description of the Related Art

The driving apparatus of a video display panel such as a plasma display panel (hereinafter, simply referred to as “PDP”) is generally configured by a video-signal processing section performing video signal processing and a display panel driving section serving performing video display processing (see, Japanese Patent Application Kokai No.2001-346131).

Herein, the video-signal processing section is a portion for performing a predetermined video-signal processing on an input video signal according to an attribute of the video signal which is input to the display panel driving apparatus. Meanwhile, the display panel driving section is a portion for driving the display panel according to a predetermined driving sequence and actually performing a video display, on the basis of the video signal made by the signal processing.

The reason of necessitating such video-signal processing is because the display driving apparatus is required to suitably display a variety of video signals that are different in signal scheme.

Namely, besides the video signals based on the standard television scheme such as the NTSC scheme, the display panel driving apparatus may be provided with a video signal different in frame frequency as compared to the NTSC scheme, e.g. video signal from a movie film source. In this instance, the video signal processing section is required to carry out a predetermined signal processing, such as telecine conversion, on the input video signal while the display panel driving section is required to drive the display panel on a driving sequence of a predetermined scheme corresponding to the signal processing scheme. This is because, in case correspondence becomes unavailable between the signal processing scheme in the video signal processing section and the driving sequence scheme in the display panel driving section, disturbance occurs in the image displayed on the display panel.

In the conventional display driving apparatus, the display panel driving section detects an attribute, such as frame frequency and the number of scanning lines, of a video signal supplied from the video signal processing section and then determines a scheme of the signal processing performed on the video signal. Then, the display panel driving section selects a driving sequence scheme corresponding to the signal processing scheme and carries out a display-panel driving processing on the basis of the driving sequence scheme. This provides an agreement between the video signal processing scheme performed on the video signal to be output from the video signal processing section and the driving sequence scheme for displaying the video signal on the display panel.

However, a predetermined time is required for detecting an attribute of a video signal in the display panel driving section and further deciding a video signal processing performed on the video signal. Accordingly, as shown in FIG. 1, when the video signal to be input to the display driving apparatus changes from attribute A to attribute B or from attribute B to attribute A, a delay is caused before determining a driving sequence scheme in the display panel driving section. Due to such a delay, during switching over a video signal, there possibly occurs a case that a driving sequence for a video signal having an attribute A corresponds to a video signal made by a signal processing as an attribute B. The inconsistency between a signal processing scheme and a driving sequence scheme is attributable for disturbance in a video image on the display panel as described above.

### SUMMARY OF THE INVENTION

The present invention has been made in order to solve the problems as described above. The problems the invention is to solve include, as one example, to provide a display driving apparatus which can improve the quality of display images upon changing over between the video signals different in attribute.

According to the present invention, there is provided a display driving apparatus which comprises a video signal processing section which performs signal processing on an input video signal to generate a resultant video signal, the signal processing corresponding to an attribute of the input video signal; and a display panel driving section which drives a display panel on the basis of the resultant video signal, according to a driving sequence corresponding to the signal processing; wherein the video signal processing section changes a scheme of the signal processing on the basis of an attribute of the input video signal and generates a sequence change signal upon changing the scheme; and the display panel driving section includes a sequence controller for changing a scheme of the driving sequence on the basis of the sequence change signal.

### BRIEF DESCRIPTION OF THE DRAWINGS

FIG. 1 is a time chart showing a correspondence between an attribute of an input video signal and a display-panel driving sequence of a conventional display driving apparatus;

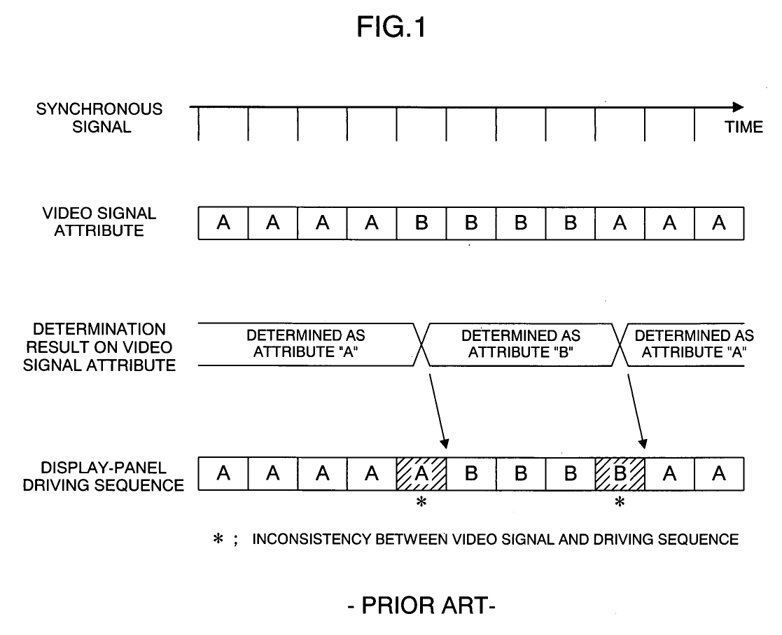

FIG. 2 is a block diagram showing one embodiment of a display driving apparatus according to the present invention; and

FIG. 3 is a time chart showing a correspondence between an attribute of an input video signal and a display-panel driving sequence of the display driving apparatus shown in FIG. 2.

### DETAILED DESCRIPTION OF THE INVENTION

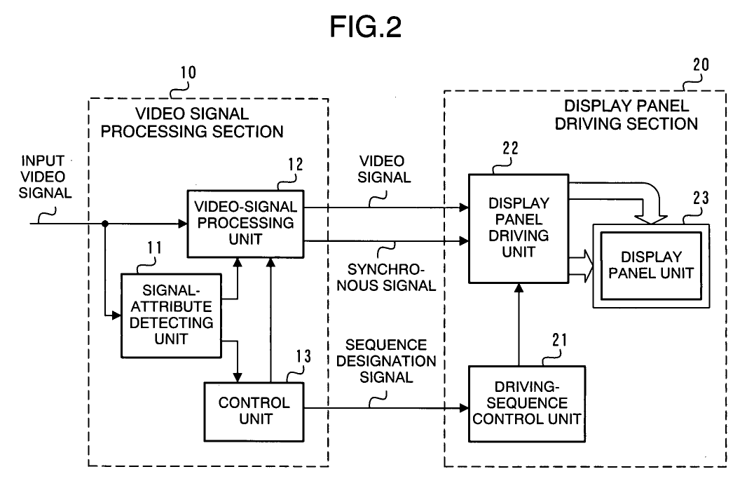

FIG. 2 shows a display driving apparatus in one embodiment according to the present invention.

In this figure, a video signal processing section 10 is a portion for performing a predetermined signal processing on a video signal which is input to the display driving apparatus, on the basis of the attribute of the signal. The video signal processing section 10 is mainly configured with a signal-attribute detecting unit 11, a video-signal processing unit 12 and a control unit 13.

The signal-attribute detecting unit 11 is a circuit for detecting an attribute of the input video signal. The attribute of the input video signal refers to a category to which the input video signal belongs, e.g. input video signal is a video signal under the standard television scheme or a video signal telecine-converted from a movie film.

The video-signal processing unit 12 is a circuit for performing a predetermined video-signal processing corresponding to the attribute of the input video signal. The video-signal processing unit 12 is configured by various circuits (not shown), e.g. a progressive-scan transforming circuit for transforming an interlaced-scanned image into a progressive scanned image, a frame-rate change circuit (frame memory) for changing the frame rate of a video signal and the like.

The control circuit 13 is configured with various circuits (not shown), such as a microcomputer, a memory circuit including a RAM and a ROM, and a peripheral circuit of these memories, to make a control on the various processing operations in the video-signal processing unit 12. Meanwhile, the control unit 13 has a capability to generate a sequence instruction signal. Note that the sequence instruction signal is to designate a display-panel driving sequence in a display-panel driving section 20, correspondingly to the signal processing performed in the video-signal processing unit 12.

The display-panel driving section 20 is mainly configured with a drive-sequence control unit 21, a display-panel driving unit 22 and a display panel unit 23.

The drive-sequence control unit 21 is configured with various circuits (not shown), such as a microcomputer, a memory circuit including a RAM and a ROM, and a peripheral circuit for the memories, to designate/control a driving sequence of the display-panel driving unit 22.

The display-panel driving unit 22 is a circuit for driving the display-panel unit 23 to display an image based on a video signal output from the video-signal processing unit 12, according to a driving sequence in accordance with a designation from the drive-sequence control unit 21. The display-panel driving unit 22 is configured, for example, with a display-data converting circuit for converting a video signal into display data and various circuits (not shown) such as a display-element driving circuit including a column driver circuit and a row driver circuit.

The display panel unit 23 is a video display panel utilizing, for example, a plasma display panel (PDP). The display elements on the display panel are driven by the display panel driving unit 22.

As shown in FIG. 2, from the video-signal processing circuit 10, supplied to the display-panel driving section 20 are a video signal which is obtained by performing a predetermined video-signal processing on the input video signal, a synchronous signal in synchronism with the video signal, and a sequence instruction signal designating a display panel driving sequence scheme corresponding to the video signal processing scheme.

Incidentally, in the display driving apparatus of the present invention, the configuration of the video-signal processing section 10 and display-panel driving section 20 is not limited to those shown in FIG. 2. For example, in the video-signal processing section 10, any two or all of the signal-attribute detecting unit 11, the video-signal processing unit 12 and the control unit 13 may be integrated in a one-chip IC to configure a video-signal processing section 10. Likewise, in the display-panel driving section 20, the drive-sequence control unit 21 and the display-panel driving unit 22 may be integrated in a one-chip IC.

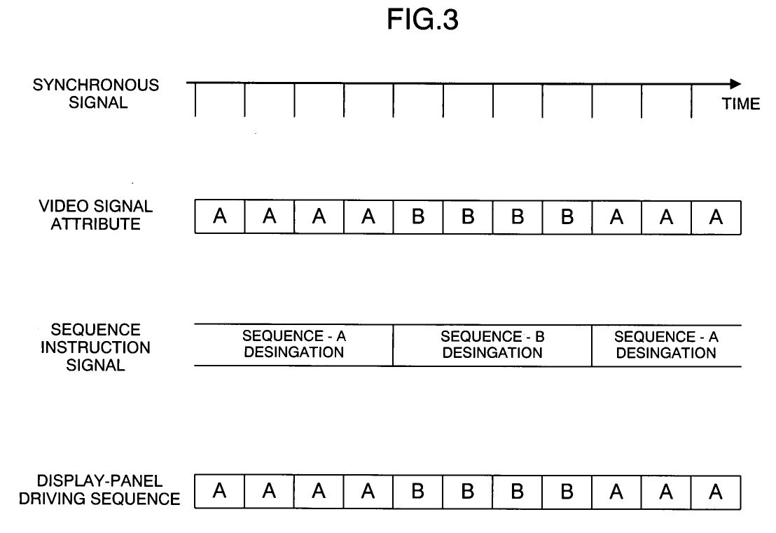

The operation of the display driving apparatus shown in FIG. 2 is described with reference to a time chart of FIG. 3.

In the embodiment, it is assumed that a video signal at an ordinary frame rate of 60 Hz is input to the display driving apparatus shown in FIG. 2.

The signal-attribute detecting unit 11 of the video-signal processing section 10 notifies a detection result to both the video-signal processing unit 12 and the control unit 13 when detecting an attribute of the input video signal. In this instance, the attribute of the video signal is represented by a symbol “A” in the time chart of FIG. 3.

The video-signal processing unit 12, receiving such a notification, performs a signal processing on the input video signal as described below.

When the input video signal is a progressive-scanned image, the progressive-scan converting circuit in the video-signal processing unit 12 allows the input video signal to pass therethrough. When the input video signal is an interlaced-scanned image, a predetermined progressive-scan converting process is performed on the input video signal to be converted into a progressive-scanned image.

The frame-rate change circuit in the video-signal processing unit 12 uses the frame rate (60 Hz) as it is of the input video signal, to supply a video signal as an output of the progressive-scan converting circuit to the display-panel driving section 20. The synchronous signal in synchronism with the video signal is also output from the video-signal processing circuit 12 to the display-panel driving section 20.

Meanwhile, the control unit 13 designates a drive-sequence scheme of display panel corresponding to a signal processing performed on a video signal having an attribute A in the video-signal processing unit 12, and outputs a sequence instruction signal representing the sequence scheme (denoted “sequence-A” in FIG. 3) to the display-panel driving section 20.

The driving sequence control unit 21 in the display panel driving section 20 determines a driving sequence scheme for driving the display panel on the basis of the video signal supplied from the video-signal processing section 10, according to the driving sequence instruction signal. The display-panel driving unit 22 actually carries out a driving processing of the display panel unit 23, according to the driving sequence scheme.

Incidentally, the state or mode in which the video signal “A” of the standard video signal scheme described above is being input to the display driving apparatus is referred to as a normal mode.

It is now assumed that the input video signal to the display driving apparatus is switched over to a telecine-converted video signal originating from a film source having M frames per second. Note that the telecine-converted image in this case assumably includes a 2-3 converted or 2-2 converted image. Meanwhile, the input video signal in this case is assumably an interlaced-scanned image having a frame rate of 60 Hz. Note that the attribute of the input video signal is represented by a symbol “B”.

The signal-attribute detecting unit 11 of the video signal processing section 10, after detecting an attribute B of the input video signal, notifies a detection result to both the video-signal processing unit 12 and the control unit 13.

Based upon the notification, the video-signal processing unit 12 causes the progressive-scan converting circuit in the same unit to carry out a field interpolation processing using an image in a field of the same film frame. By performing the processing, the input video signal is converted into a progressive-scanned image having a frame rate of 60 Hz. Incidentally, when the input video signal is a telecine-converted (2-3 converted or 2-2 converted image) progressive-scanned image having a frame rate of 60 Hz originating from a film source having M frames per second, the progressive-scan converting circuit merely allows the input video signal to pass therethrough.

The output from the progressive-scan converting circuit is further converted into a video signal in which the same film frame is repeated N times (N is a natural number greater than or equal to 2) per 1/M second by a frame-rate changing circuit (frame memory) in the video-signal processing unit 12.

For example, when the repetition number of the same image N and the number of frames M of the film source are respectively

N=3 times and M=24 frames,

then the video signal is given as a signal that 3 frames are repeated for 1/24 second. Accordingly, the time per frame in this case is

1/(24×3)=1/72 second.

Thus, the video signal is converted in frame rate from 60 Hz to 72 Hz.

The video signal on which the above-described signal processing has been performed in the video-signal processing unit 12 is output from the video-signal processing section 10 to the display-panel driving section 20.

Incidentally, it is needless to say that, together with outputting the video signal, a synchronous signal in synchronism therewith is output from the video-signal processing section 10 to the display-panel driving section 20.

Meanwhile, the control unit 13 designates a driving sequence scheme of display panel corresponding to a signal processing performed on the video signal having an attribute B in the video-signal processing unit 12 to output a sequence instruction signal designating the sequence scheme (denoted “sequence-B” in FIG. 3) to the display-panel driving section 20.

In the display-panel driving section 20, when the driving sequence control unit 21 received the sequence instruction signal, the driving sequence scheme of display panel in the display-panel driving unit 22 is switched from the sequence-A scheme to a sequence-B scheme.

The switching of the display panel driving sequence will now be described in detail.

For example, when the frame rate is changed from 60 Hz to 72 Hz by a signal processing in the video-signal processing section 10 as in the case described above, the driving sequence control unit 21 instructs the display-panel driving unit 22 to change the field frequency (change from 60 Hz to 72 Hz) or the number of sub-fields (e.g. deleting a less-weighted sub-field and reducing the number of sub-fields).

Alternatively, the drive-sequence control unit 21 may change the number of sub-field sustain pulses when changing the field frequency. For example, the number of sustain pulses in each sub-field may be reduced when changing the field frequency from 60 Hz to 72 Hz.

Incidentally, the state in which the telecine-converted video signal “B” described above is being input to the display driving apparatus is referred to as a cinema mode.

Thereafter, as the input to the display driving apparatus is returned from the cinema mode to the normal mode, the sequence instruction signal is changed (i.e., from sequence-B designation to sequence-A designation) in response to an attribute change of the video signal (i.e., from B to A). Incidentally, the signal processing in the video-signal processing section 10 upon return to the normal mode and the driving sequence process in the display-panel driving section 20 is similar to the processing described above.

As described in detail above, according to the display driving apparatus shown in FIG. 2, the signal processing performed on an input video signal and the driving sequence for displaying the signal can be simultaneously switched over in the timing the attribute of the input video signal is switched over, thereby preventing a disturbance in the display image. Meanwhile, even when the frame rate of video signal is automatically converted to a predetermined value and the driving sequence for the display panel is switched over in accordance therewith in the cinema mode, the driving sequence corresponding to the image changed in frame rate can be switched over in the optimal timing. Thus, display image can be prevented from being disturbed.

The invention has been described with reference to the preferred embodiments thereof. It should be understood by those skilled in the art that a variety of alterations and modifications may be made from the embodiments described above. It is therefore contemplated that the appended claims encompass all such alterations and modifications.

This application is based on Japanese Patent Application No.2003-41455 which is hereby incorporated by reference.

What is claimed is:

1. A display driving apparatus comprising:
a video signal processing section which performs signal processing on an input video signal to generate a resultant video signal, the signal processing corresponding to an attribute of the input video signal; and
a display panel driving section which drives a display panel on the basis of the resultant video signal, according to a driving sequence corresponding to the signal processing; wherein
the video signal processing section changes a scheme of the signal processing on the basis of an attribute of the input video signal and generates a sequence change signal upon changing the scheme; and
the display panel driving section includes a sequence controller for changing a scheme of the driving sequence on the basis of the sequence change signal.

2. A display driving apparatus according to claim 1, wherein the video signal processing section further includes a frame rate converter which converts a frame rate on the basis of the attribute of the input video signal, and the sequence change signal includes information of changing the frame rate.

3. A display driving apparatus according to claim 1, wherein the sequence controller changes the number of sub-fields constituting one field of the video signal, on the basis of the sequence change-over signal.

4. A display driving apparatus according to claim 1 or 2, wherein the sequence controller changes the number of display pulses assigned to each of the sub-field constituting one field of the video signal, on the basis of the sequence change signal.
